(19) United States
(12) Patent Application Publication
(10) Pub. No.: US 2007/0063835 A1
(43) Pub. Date: Mar. 22, 2007

(54) Wearable variable resistor

(75) Inventors: George Marmaropoulos, Yorktown Heights, NY (US); Giang Truong Vu, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Kininklijke Philips Electronics N.V., Eindhoven (NL)

(21) Appl. No.: 10/557,491

(22) PCT Filed: May 19, 2004
(86) PCT No.: PCT/IB04/01691

§ 371 Date: Nov. 21, 2005

(30) Foreign Application Priority Data
May 23, 2003 (US) 60/473,118

(51) Int. Cl. G08B 21/00

(52) U.S. Cl. 340/540

(57) ABSTRACT

The present invention is directed to a variable resistor for use in a garment. The variable resistor includes a channel. Conductive areas are disposed in an inner wall of the channel. A conductive object is in the channel contacting the conductive areas. The conductive object movable within the channel to provide a variable resistance. In one example, the channel extends within fabric of the garment. In another, the channel extends within a draw string of the garment. Further, the conductive areas include conductive fibers woven into the inner wall.

The present invention relates generally to wearable electronics, and more particularly, to a variable resistor device for controlling electronic devices in wearable electronic applications.

Wearable electronics involves the integration of electronic items with fabric and garments. Examples of these are personal stereos, heart rate monitors, bio-feedback sensors, telephone headsets, data line connections, microprocessors, computerized components, etc. Some of these devices use variable resistors as control devices such as dimmer switches for illumination or volume control for audio.

However, variable resistors are typically made from materials that are different than the materials used in garments. Further, the techniques used to make variable resistors are also different than the ones used to make garments. Therefore, the need exists for a variable resistor device that is readily adaptable to garment manufacturing techniques and materials.

The present invention is directed to a variable resistor for use in a garment. The variable resistor includes a channel. Conductive areas are disposed in an inner wall of the channel. A conductive object is in the channel contacting the conductive areas. The conductive object moves within the channel to provide a variable resistance. In one example, the channel extends within fabric of the garment. In another, the channel extends within a draw string of the garment. Further, the conductive areas include conductive fibers woven into the inner wall.

The present invention is also directed to a method of making a variable resistor in a garment. The method includes a channel formed in the garment. Conductive areas are formed in an inner wall of the channel. A conductive object is placed in the channel contacting the conductive areas. In one example, the channel is formed within fabric of the garment. In another example, the channel is formed within a draw string of the garment. Further, the conductive areas include conductive fibers woven into the inner wall.

Referring now to the drawings were like reference numbers represent corresponding parts throughout:

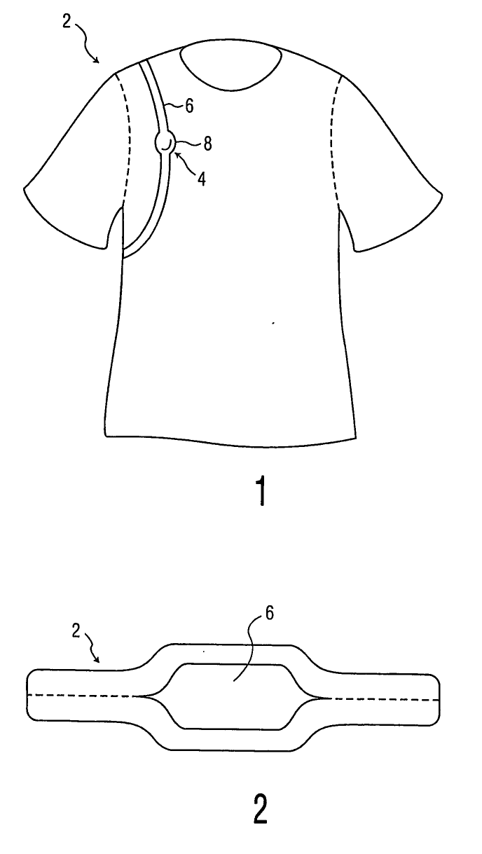

FIG. 1 is one example of a garment including the wearable variable resistor according to the present invention;

FIG. 2 is a cross sectional view of the channel in the example of FIG. 1;

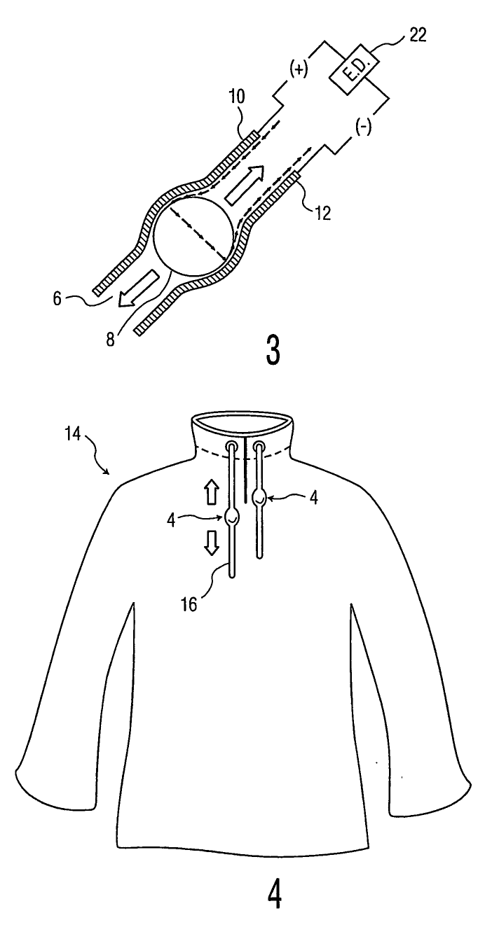

FIG. 3 is an inner view of channel in the example of FIG. 1;

FIG. 4 is another example of a garment including the wearable variable resistor according to the present invention;

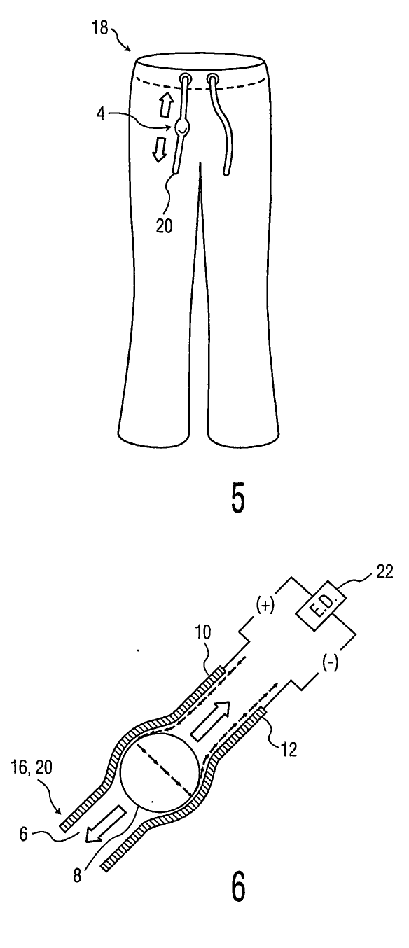

FIG. 5 is another example of a garment including the wearable variable resistor according to the present invention; and

FIG. 6 is an inner view of the draw string in the example of FIGS. 4-5.

One example of a garment including the wearable variable resistor according to the present invention is shown in FIG. 1. As can be seen, the garment in this example is a shirt 2. According to the present invention, the garment 2 includes a variable resistor device 4 that can be used to control electronic devices. For example, the variable resistor device 4 may be a volume control for an audio device or a dimmer for an illumination device.

As can be seen, the variable resistor 4 includes a channel 6 that is integrated into the garment 2. In this embodiment, the channel 6 is shown extending from the right shoulder to the middle right side of the garment 2. However, other configurations are contemplated. For example, the channel 6 may extend from the other shoulder, diagonally across the front of the garment, horizontally across the top, middle or bottom of the garment.

As can be further seen, a conductive object 8 is included in the channel 6. During operation, the conductive object 8 will move within the channel 6 in order to change the: resistance of the device. This will be described in more detail below.

A cross sectional view of the channel in the example of FIG. 1 is shown in FIG. 2. In this example, the channel 6 is integrated into the fabric of the garment 2. As can be seen, the fabric splits into two layers to form the channel 6. The channel 6 may be formed by fusing two separate layers of fabric together.

Alternatively, the channel 6 may be woven into the fabric itself. This can be done by either a circular or flatbed knitting machine. Both types of machines include a front and back needle which work together to form a single layer knit structure. If the two needles are separated, a two layer structure is formed. Thus, in order to form the channel, the needles would be separated in the area of the garment where the channel is desired. An example of a circular knitting machine is made by Santoni and an example of flat bed knitting machine is made by Stoll.

An inner view of the channel 6 in the example of FIG. 1 is shown in FIG. 3. As can be seen, the inner wall of the channel 6 includes two conductive areas 10,12. The conductive areas 10,12 are preferably made from conductive fibers such as stainless steel or silver plated synthetic fiber. It is also preferable that the conductive areas 10,12 are woven into the inner wall of the channel 6 along with rest of the garment. As can be further seen, a conductive object 8 is disposed in the channel 6 and in contact with the two conductive areas 12. The conductive object 8 enables current to flow between the conductive areas 10,12 when connected to an electrical device. Therefore, as the conductive object 8 moves within the channel 6 the area of the conductive areas 10,12 included in the circuit will change providing a variable resistance.

It is preferred that the conductive object 8 have a spherical or elliptical (bullet) shape, which will enable it to move freely within the channel 6. It also preferred that the conductive object 8 have a larger diameter than that of the channel 6. This will ensure that the conductive object 8 stays in contact with the conductive areas 10,12. Also, having a larger diameter will enable the conductive object 8 to stay in place within the channel 6 when not being moved.

During operation, an electrical device 22 is connected to the conductive areas 10,12 as shown in FIG. 3. The electrical device 22 may be a personal stereo, MP3 player, an illumination device, radio station tuner. In order to vary the resistance of the device, a user would squeeze the outside of the channel 6 where the conductive object 8 is located. In this example, if the conductive object 8 is moved upward in the channel 6, less of the conductive areas 10,12 will be included in the circuit thereby decreasing the resistance. Further, if the conductive object 8 is moved downward in the channel 6, more of the conductive areas 10,12 will be included in the circuit thereby increasing the resistance. Another example of a garment including the wearable variable resistor according to the present invention is shown in FIG. 4. In this example, the garment is a jacket. Further, in this example, two variable resistors 4 are incorporated into a draw string 16 of the garment 14.

Another example of a garment including the wearable variable resistor according to the present invention is shown in FIG. 5. In this example, the garment 18 is pants and the variable resistor 4 is also incorporated into a draw string 20.

An inner view of the draw string in the example of FIGS. 4-5 is shown in FIG. 6. As can be seen, the inner structure of the draw string 16,20 is similar to the structure of the first example. The draw string 16,20 has a hollow tubular structure that also includes a channel 6. The draw string 16,20 is preferably made by knitting it on a braiding machine, which works similar to a circular knitting machine. The draw string 16,20 can be braided from a wide variety of natural and synthetic textile fibers including cotton, lycra, acrylic, etc.

As can be seen, the inner wall of the channel 6 also includes two conductive areas 10,12. The conductive areas 10,12 are preferably made from conductive fiber such as stainless steel or silver plated synthetic fiber. Further, a conductive object 8 is also disposed in the channel 6 and in contact with the two conductive areas 12. It is preferred that the conductive object 8 have a spherical or elliptical (bullet) shape and have a larger diameter than that of the channel 6.

During operation, an electrical device is connected to the conductive areas 10,12, as shown FIG. 6. In order to vary the resistance of the device, a user would squeeze the outside of the channel 6 where the conductive object 8 is located. In this example, if the conductive object 8 is moved upward in the channel 6, the resistance is reduced. Further, if the conductive object 8 is moved downward in the channel 6, the resistance is increased.

The description of the present invention have been presented for the purpose of illustration and description. It is not intended to limit the invention to the precise structures or configurations disclosed. Many modifications and variations are possible in light of the above teachings. Therefore, it is not intended that the scope of the invention should be limited by the detail description

1. A garment, comprising:
a channel;
conductive areas disposed in an inner wall of the channel; and
a conductive object in the channel contacting the conductive areas, wherein the conductive object moves within the channel to provide a variable resistance.

2. The garment of claim 1, wherein the channel extends within fabric of the garment.

3. The garment of claim 1, wherein the channel extends within a draw string of the garment.

4. The garment of claim of claim 1, wherein the conductive areas include conductive fibers woven into the inner wall.

5. The garment of claim 1, wherein the conductive object has a larger diameter then the channel.

6. The garment of claim 1, wherein an electrical device is connected to the conductive areas.

7. A variable resistor device for use in a garment, comprising:
a channel;
conductive areas disposed in an inner wall of the channel; and
a conductive object in the channel contacting the conductive areas, wherein the conductive object moves within the channel to provide a variable resistance.

8. The device of claim 7, wherein the channel extends within fabric.

9. The device of claim 7, wherein the channel extends within a draw string.

10. The device of claim of claim 7, wherein the conductive areas include conductive fibers woven into the inner wall.

11. The device of claim 7, wherein the conductive object has a larger diameter then the channel.

12. The device of claim 7, wherein an electrical device is connected to the conductive areas.

13. A method of making a variable resistor in a garment, comprising:
forming a channel in the garment;
forming conductive areas in an inner wall of the channel; and
placing a conductive object in the channel contacting the conductive areas.

14. The garment of claim 13, wherein the channel is formed within fabric of the garment.

15. The method of claim 13, wherein the channel is formed within a draw string of the garment.

16. The method of claim 13, wherein the conductive areas include conductive fibers woven into the inner wall.

17. The method of claim 13, wherein the conductive object has a larger diameter then the channel.
